(19) United States
(12) Patent Application Publication
(10) Pub. No.: US 2014/0104206 A1
(43) Pub. Date: Apr. 17, 2014

(54) CREATION OF THREE-DIMENSIONAL GRAPHICS USING GESTURES

(71) Applicant: Glen J. Anderson, Portland, OR (US)

(72) Inventor: Glen J. Anderson, Portland, OR (US)

(21) Appl. No.: 13/977,337

(22) PCT Filed: Mar. 29, 2012
(86) PCT No.: PCT/US12/31264

§ 371 Date: Jan. 2, 2014

(51) Int. Cl. G06T 19/20; G06F 3/01; G06F 3/041; G06F 3/0488

(52) U.S. Cl. CPC G06T 19/20; G06F 3/04883; G06F 3/017; G06F 3/041
USPC 345/173

(57) ABSTRACT

Three-dimensional virtual objects are created using gestures. In one example, a selection of a shape is received. The selected shape is presented on a display. A gesture is observed to move at least a part of the presented shape away from the display and the presented shape is modified based on the observed gesture in the direction away from the display corresponding to the observed gesture. The modified shape is presented as a three dimensional virtual object after modifying the presented shape based on the observed gesture.

### FIELD

The present application relates to the field of creating graphical objects in a computing or gaming environment and, in particular, to adding a third dimension to an object using user gestures.

### BACKGROUND

The advent of three-dimensional (3D) graphics rendering changed the nature of computer and video gaming and has now become used in many more applications and even in user interfaces. 3D displays that allow a user to see a 3D image allow the existing 3D graphics rendering to be displayed with the additional depth that was latent within the rendering image. The advent of stereoscopic cameras and inexpensive inertial sensors in handheld pointing devices has enabled 3D motions to be used as input applied to 3D rendered objects.

As input systems, peripheral devices with motion and inertial sensors have been used. The peripheral may be in the form of a motion sensitive glove or a controller. Alternatively, cameras have been used to detect 3D free hand or air gestures to create and manipulate 3D models that appear on a screen.

Touch screens and track pads are also used in the creation and manipulation of 3D objects. Mouse and touchpad input has also been used for creating designs in two and three dimensions.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1A is a diagram of drawing a 2D shape on a touch screen device according to an embodiment of the invention.

FIG. 1B is a diagram of the drawn 2D shape on the touch screen device according to an embodiment of the invention.

FIG. 1C is a diagram of grasping a part of the drawn 2D shape on the touch screen device according to an embodiment of the invention.

FIG. 1D is a diagram of pulling the drawn 2D shape on the touch screen device into a third dimension according to an embodiment of the invention.

FIG. 2A is a diagram of another 2D shape on a touch screen device and of pulling a part of the 2D shape into a third dimension according to an embodiment of the invention.

FIG. 2B is a diagram the extended 3D of FIG. 2A with a ball rolling down a 3D shape as might be seen on a 3D display according to an embodiment of the invention.

FIG. 3 is a diagram of manipulating a shape in 3D on a touch screen device using fingers of two hands at the same time according to an embodiment of the invention.

FIG. 4A is a diagram of another 2D object in the form of a circle on a touch screen device according to an embodiment of the invention.

FIG. 4B is a diagram of the 2D circle on the touch screen device and a user pulling a central part of the sphere away from the screen of the device according to an embodiment of the invention.

FIG. 4C is diagram of the 2D circle converted into a 3D sphere by the user and rendered on the touch screen device according to an embodiment of the invention.

FIG. 5A is a diagram of virtual binding on the screen of a portable computer according to an embodiment of the invention.

FIG. 5B is a diagram of manipulating the virtual binding on the screen in a third dimension according to an embodiment of the invention.

FIG. 6 is a process flow diagram of changing a 2D shape into a 3D shape using a user gesture according to an embodiment of the invention.

FIG. 7A is a process flow diagram of augmenting a shape in three dimensions according to an embodiment of the invention.

FIG. 7B is a process flow diagram of manipulating a rendered 3D object using air gestures according to an embodiment of the invention.

FIG. 8 is block diagram of a computer system suitable for implementing processes of the present disclosure according to an embodiment of the invention.

FIG. 9 is a block diagram of a an alternative view of the computer system of FIG. 8 suitable for implementing processes of the present disclosure according to an embodiment of the invention.

### DETAILED DESCRIPTION

3D objects can be created and manipulated by a combination of touch screen and air gesture input. Touch and gesture may be used together in games. For example, a touch screen or other input may be used to create designs and game parts and then the air gestures, which may or may not start with a touch screen gesture, may be used to pull those objects into a 3D representation of that object. The depth of the third dimension may be made dependent on the distance traversed by the gesture.

This coordinated method of touch and air gesture input allows for a variety of creative and fun computing interactions before the objects are pulled into the third dimension.

In one example, a user draws a design on the screen. The user can then use a touch gesture to pinch a section of the design. Starting from the touch gesture, the user then pulls the pinched section of design to stretch the design into the third dimension. The 3D display may be simulated with 2D graphics, or it may be an actual 3D display. In another example a user traces a path in the air in front of the computer to create a 3D path to be used in a game. After the user traces a 3D path, then a virtual object (for example, an orange ball) can be rolled down the path. In another example, the user lays out a shape and then controls it with gesture input.

The nature of the 3D air gesture may be adapted to suit different applications and provide different user experiences. In one example, pushing on the screen harder can make deeper depth in manipulating or stretching a drawn or virtual object. In another example, using the first finger as a base or an anchor, a second finger can move away from the first finger to establish a length of an object in the z-axis. In another example, a user marks a range of 3D manipulation by stretching with two hands or with two fingers. The user might also use a voice command to cause the shape to appear on the screen before the 3D manipulation.

The created 3D object may be applied to different categories of uses. In one example, 3D layouts can be created for games, such as an onscreen version of Chutes and Ladders. In another example, a path can be created for virtual objects to slide or roll on. In another example, a 3D version of a line rider or other path following game can be created. 3D objects may also be created for artistic and engineering creation and visualization

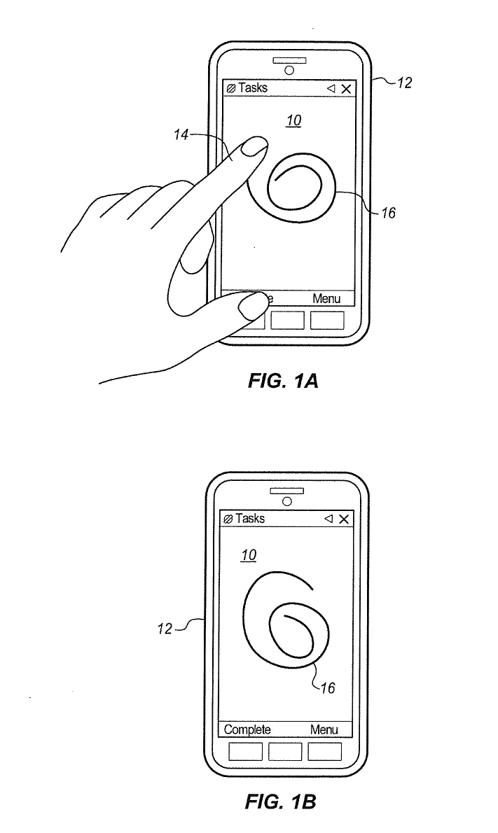

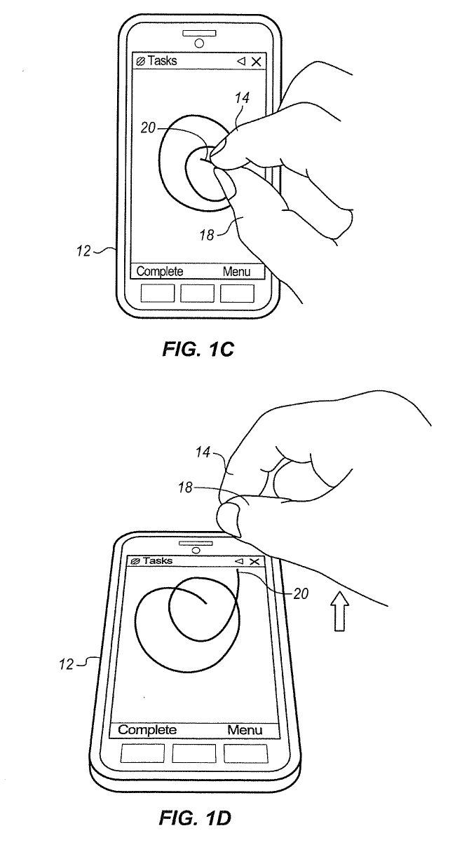

FIG. 1A is a diagram of a touch screen 10 on a supporting device 12. A user draws a shape 16 on the screen using a finger 14. In FIG. 1B the completed 2D shape can be seen. This shape can represent a track or guide way for a game or artistic application, or a metal or molecular coil of any type for an engineering or scientific application.

In FIG. 1C, the user grasps the shape 16 with a finger 14 and thumb 18 at one part 20 of the 2D shape. In FIG. 1D, the user makes an air gesture to lift the grasped section in a third dimension out of the place of the touch screen 10. This creates a third dimension to the shape. The shape now appears to be a circular slide or a coil spring, depending upon the application. The amount of extension into the third dimension may be shown in perspective on the display or with a 3D display the added dimension may be rendered as the third dimension on the 3D display.

In the illustrated example, the touch screen device is shown as a smartphone, but the invention is not so limited. With a smartphone implementation, the touch screen may be used to produce drawings with a finger or stylus. The air gesture may be observed by a front camera typically used for video conferencing. Stereo front cameras may be provided on the device in order to more accurately observe the air gesture. The stereo front camera may also be used for 3D video conferencing or video recording. The same approach may be used with a similarly equipped touch pad, media player, slate computer, notebook computer, or a display of a desktop or all-in-one machine. Dedicated gaming devices may be used as well. The drawing may be on the screen which displays the drawing as shown or the drawing and air gesture may be made on a separate touchpad with the display on a different surface as in a typical notebook computer configuration with separate touchpad and display. The display 10 and device 12 may be used as a separate device or as an input device for a larger system with additional displays, cameras, and also with additional processing resources.

The features of the drawing 16 may be further defined by other user controls. These controls may allow the user to identify the nature of the item, establish an application context for the item, and define dimensions. A user might, for example, indicate that a coil spring is made of a particular steel alloy with a particular gauge and base radius. This information may be used for setting the parameters of game play or for engineering or scientific purposes. The user may select such parameters directly or the parameters may be implied by an application. An application may, for example, prompt a user to create a particular item with parameters that are already defined by the application or the user may select a particular item with predefined parameters. After the item is determined, then the drawn shape can be defined based on the selected item.

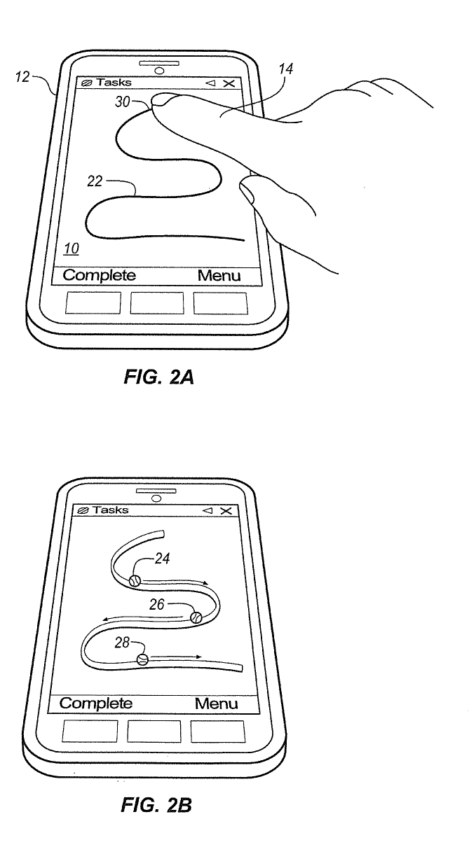

FIG. 2A shows another example in which a user draws a different shape 22 on the screen or touch surface 10 of a portable device 12 using a finger 14. The user then establishes a grasp on a portion 30 of the shape 22 and lifts that portion above the screen. In the illustrated example rather than a grasping motion, the grasp is established with a touch and hold motion. The touched part of the shape then becomes “sticky” and follows the user's finger 14 until it is released.

FIG. 2B shows the resulting 3D shape. In this example, the 3D shape is a path, track or guide way in which the added third dimension corresponds to height. The user may then place balls, riders, sleds, cars, or other objects onto the 3D shape to cause the placed items to travel down the path. As shown, the user has placed a series of balls 24, 26, 28 which roll down the path.

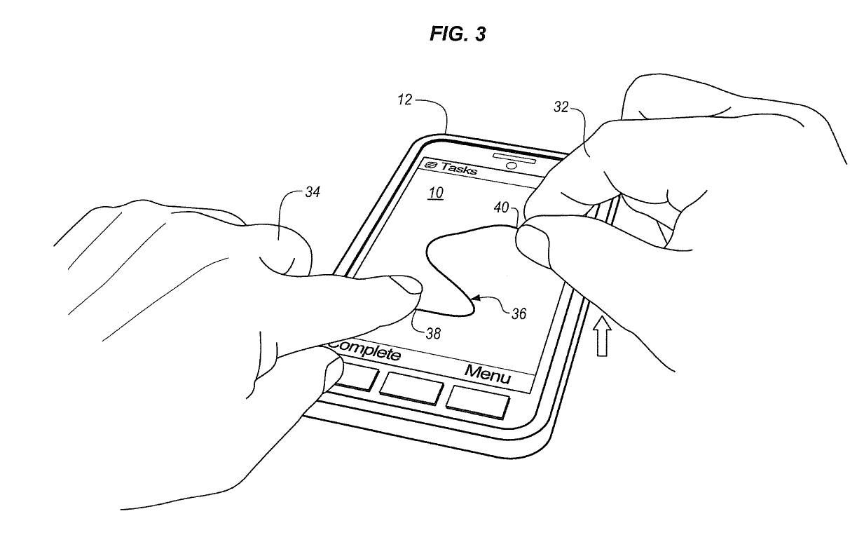

FIG. 3 shows another example in which a user uses two hands 32, 34 to grasp a shape 36 on the display 10 of the device 12. Using two hands, the user can push and pull in different directions to define dimensions of the shape in the plane of the screen and also in the third dimension. In the illustrated example, the user has applied a finger of one hand 34 to secure the position of a first part of the shape 36. With the other hand 32, the user has grasped another part of the shape. When the user lifts with the grasping hand 32, the grasped portion is lifted while the held portion remains in the plane of the screen. The two-handed gestures allow a greater variety of different shapes to be created with more precise control over the shapes.

In all of the examples above, the user adds a third dimension to a two dimensional shape by selecting a portion of the shape and lifting it away from the screen. This may be done using a grasping gesture or by indicating a grasping command, such as touch and hold. The pulling or lifting gesture is an air gesture observed by one or more cameras on or near the device. While the original shape is indicated as being drawn by the user this is not essential to the invention. The user may select a predefined shape from an application library or an external location. Shapes may also be obtained using a camera.

As an alternative to the lifting or pulling motion, the user may alternatively, or in addition, push parts of the shape downwards into the screen. The duration or pressure of the push may be used to determine the distance away from the plane of the screen. The duration or pressure may be detected by the touch screen surface or by the camera. Pushing may be combined with lifting to move portions of the shape in both directions and define the third dimension in both directions. This may be referred to as the z-axis, where the touch screen occupies the x and y axes. With a vertical display rather than a horizontal display, the third dimension may be in the x or y axis while the display occupies the z axis and either the x or y axis. While the user manipulates the object, feedback may appear on the screen showing the direction of 3D displacement, the degree of 3D displacement, and other aspects to allow the user to know that input is being received and the degree of change that is resulting from the user input.

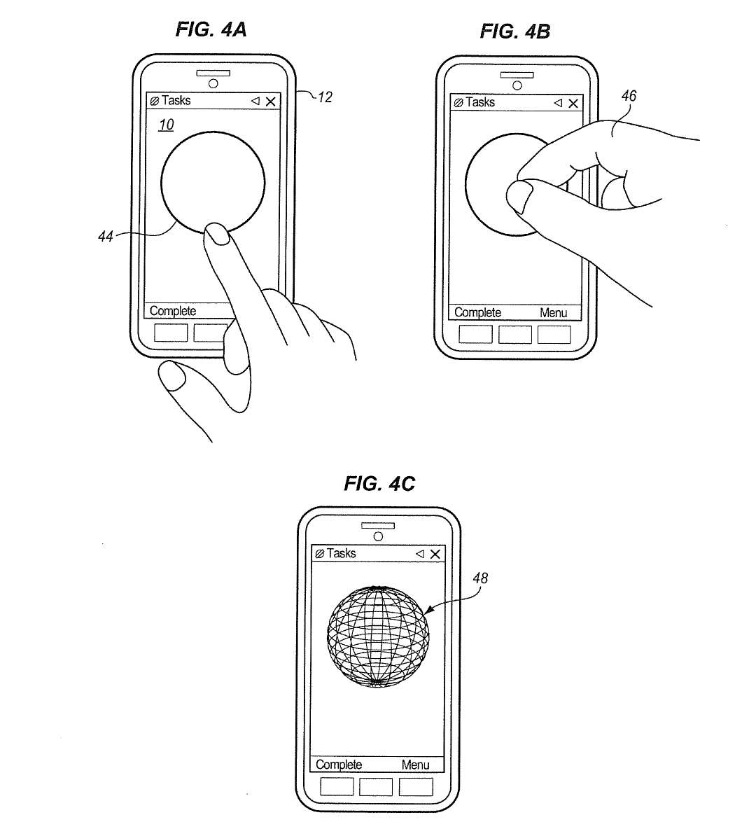

While the example above used curves, the same techniques may be applied to lines and to enclosed shapes with an internal area. FIG. 4A shows a circle 44 on the touch surface 10 of the device 12. In FIG. 4B, the user 46 grasps the center of the circle and lifts it up from the surface. The result in FIG. 4C is a 3D sphere 48. With more or less lifting the 3D volume may be created as an elliptical volume. Any closed 2D area may be used with this approach to add volume in the third dimension to a particular portion of the area or, as in FIG. 4C, uniformly to the entire area. A triangle may be converted to pyramid. A square may be converted into a cube, etc. This added dimension may be presented on a 2D or a 3D display.

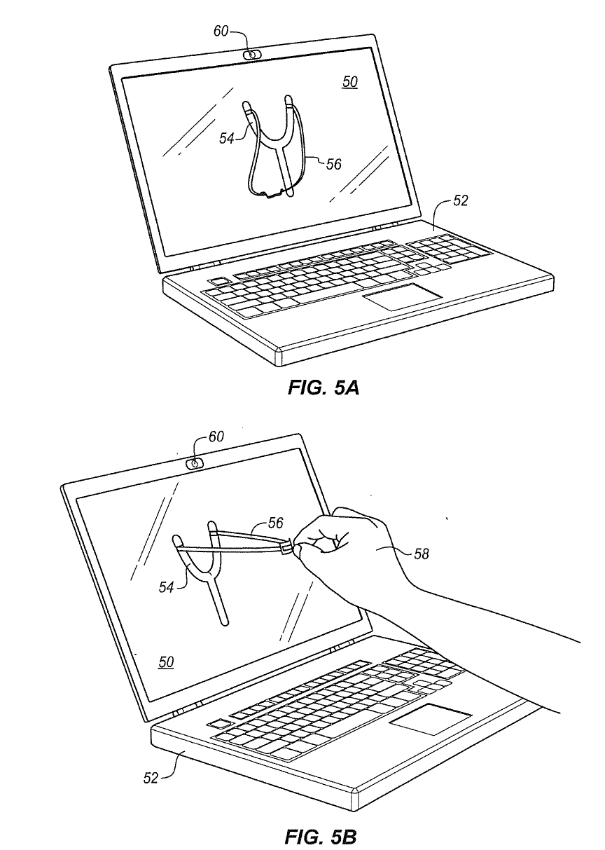

The 2D objects may be used in any of a variety of different ways. In FIG. 2B balls are rolled down a ramp or chute. In FIG. 5A, a slingshot 54 has been created on the display 50 of a notebook computer 52. Any type of display or computing device may be used as mentioned above, such as a desktop touch screen computer or a slate computer held in stand. The slingshot has a strap 56 for launching projectiles. The display may be considered as occupying the x and y axes. However, as with all of the other examples, the names of the axes and the type of coordinate system may be adapted to suit any particular application.

In FIG. 5B, a user has grasped the strap and pulled it away from the screen in the direction of the negative y axis. This stretches the strap which is a type of virtual binding. Upon the user's release of the strap, a virtual projectile may be launched from the slingshot toward an object shown in the positive y axis in the display. The projectile may be selected or placed in the strap by the user or it may be supplied by an application without user input. The air gesture of the user may be observed by one or more cameras 60 built into or coupled to the display.

The same grasp and lift air gesture of the previous figures is used in FIG. 5B to move an object away from the screen. In this case, the object is the slingshot strap. A similar principle may be applied to catapults, various levers, etc. The motion of the user may be used not only to move the strap directly away from the display but also to aim the slingshot. The user may move the grasped portion of the strap up and down and side to side as well as forward and backwards in order to adjust the release position for the virtual bindings. In the case of the slingshot this allows the sling shot to be precisely aimed and for the force applied to the projectile to be controlled. In the same way, in the examples of FIGS. 1C and 2A, the user may move the grasped portion of the shape in different directions to also adjust its x and y dimensions as well as its z axis dimension.

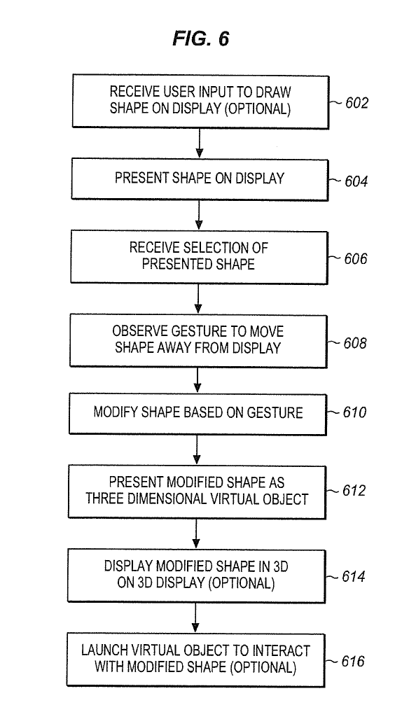

FIG. 6 is a process flow diagram showing one example of the operations described above from the perspective of the system with which the user is interacting to create and use three dimensional objects. The process flow may occur during the operation of another program or as a start or continuation of a separate process. The process may start in a variety of different ways, depending on the particular implementation. At 602 the process starts by receiving user input to draw a shape on a display. The user input may be touch screen, touch pad, or air gestures or it may by input applied by a mouse or a dedicated drawing device.

As an alternative to receiving a drawing input the shape may be selected from a library or imported from a source of different shapes. The shape may be a curve, a line, an enclosed area, a picture, or any of a variety of other shapes. The shape may be a two dimensional shape or a three dimensional shape.

At 604, the shape is presented on a display and at 606, the shape is selected by a user. The shape is typically presented on a flat surface as a flat surface and the user may select the shape by an air gesture, a touch gesture or using a pointing device. However 3D shape may instead be presented on the flat screen surface.

At 608, a gesture is observed to move at least a part of the presented shape away from the display. The gesture may be an air gesture or it may be a touch gesture. In one example, the gesture is a grasping of a part of the shape and then a pulling away from the display into the air in front of the display. The user may also gesture a twisting motion or other motion to cause the object to rotate or distort. The gesture may be a movement in all three dimensions so that it defines not only a distance away from the display but also a horizontal and vertical distance away from the starting point of the grasping motion. For a shape that is originally two dimensional, the gesture indicates how the shape is to become three dimensional. For a three dimensional shape, the gesture may modify its three dimensional characteristics.

In another example, the gesture is a push into the display and the amount of pressure or the amount of time determines how far the selected part of the shape is moved away from the plane of the display. As with the pulling, the pushing may also have horizontal and vertical movement. As shown above, the user may use two hands or two fingers to hold one part of the original shape and move another. This more precisely defines which parts are to be moved and which parts are not to be moved.

The pulling or pushing of the shape may be accompanied by sound effects to provide confirmation of the received command. In one example, the sound effect may be a stretching sound that changes in pitch to indicate the extent of travel away from the display or away from the starting point. Other sound effects may be used to indicate movement such as scratching or friction effects.

With each gesture there may be an original start gesture, such as a grasping motion, a movement gesture, such as a movement of the hand or instrument, and then an end gesture such as a release. If the gesture is performed with a peripheral device then a button on the device may be used to indicate the start and end. If the gesture is made with a hand, finger movements or voice commands may be used, or the other hand may be used to indicate the start and end with gestures, button presses, or in other ways.

At 610, the originally presented shape is modified based on the observed gesture. The modification will be in the direction away from the screen that corresponds to the observed gesture. In some cases, the presented shape will be modified by adding a third dimension to the original two dimensional shape to generate a three-dimensional shape.

At 612, the modified shape is presented as a three dimensional virtual object. The modified shape may be presented on a 3D display at 614 or shown with perspective on a 2D display. The shape is presented as a virtual object in that it is a displayed object not a real object. The 3D shape may then be applied to a variety of different uses as discussed above. The 3D shape may be used in a computer-aided design system. It may be used in any of a variety of engineering or scientific applications. It may also be used for later interactions.

In some cases, as at 616, the 3D shape may optionally be used to launch a virtual object. The virtual object may interact with the modified shape and this interaction may be presented on the display. The rolling balls and the sling shot launched projectiles are examples of such interactions. User gestures may also be received as a user interaction with the modified shape, such as the sling shot shown above. These interactions may be presented on the display for use, review or entertainment of the user.

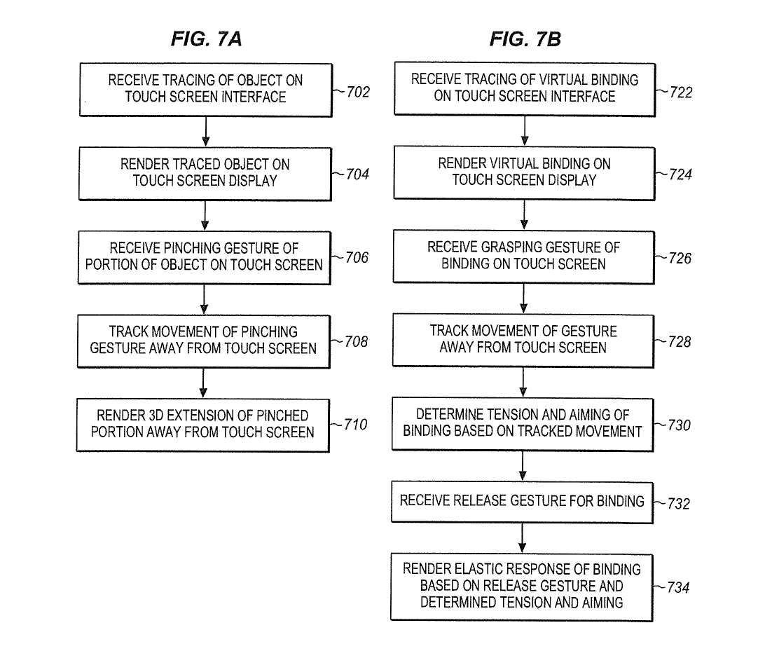

FIG. 7A is a process flow diagram of a more generalized example of the usage cases described above. At 702, a touch screen device, such as a tablet or slate computer, a smart phone, a media player or a game console or controller receives a tracing of an object on its touch screen interface. The drawing can be drawn by a user's finger on the screen which detects the position of the finger and its movement across the display. Alternatively, a stylus or other dedicated device may be used. The touch screen in such a device is typically also a display. At 704, the device renders the traced object on its touch screen display.

At 706, the device receives a pinching gesture of a portion of the traced and displayed object on its touch screen. At 708, the device tracks the movement of the pinching gesture away from its touch screen. The movement may be tracked by proximity sensors that are associated with some touch screens or with cameras that observe the user's pinching gesture. Other technologies to determine the position of the pinching gesture with respect to the touch screen may be used.

At 710, the device renders a 3D extension of the pinched portion of the traced object away from its touch screen. This may be done using perspective, elevation projections, or a 3D display. This rendering results in the coil spring, the raised track, the sling shot, the beach ball or any of the other objects shown in the examples described above.

FIG. 7B is a process flow diagram of particular operations that may be used for the virtual bindings example described above. At 722, the touch screen device receives a tracing of a virtual binding on its touch screen interface. This device may be of the same type as the devices described above. The virtual binding may be a sling shot as mentioned above, a catapult, an archery bow string, a pneumatic cannon, or any other type of virtual binding. At 724, the device renders the virtual binding on its touch screen display.

At 726, the user is able to use the rendered virtual binding. To do so, the user grasps the virtual binding. This may be by grasping at the rendering or a strap, a handle, a lever, or any other aspect of the device. The device receives the grasping gesture of the binding on its touch screen. Typically this is done by a hand gesture that can be detected on the touch screen. The grasping gesture, as with the pinching gestures at 706, identifies the portion of the rendering that is to be grasped. At 728, the user moves the grasping or pinching hand away from the touch screen. The device tracks the movement of the gesture away from its touch screen. The gesture is now an air gesture without direct contact with the touch screen.

At 730, the device determines tension and aiming of the virtual binding based on the tracked movement. At 732, the device receives a release gesture for the binding. This can be delivered by the user making a releasing gesture or by the user making any of a variety of other gestures, depending upon the context.

At 734, the device renders an elastic response of the virtual binding based on the received release gesture and the determined tension and aiming. This typically will be launch of some sort of projectile, such as a stone or an arrow. The particular result of releasing the binding will depend upon what the binding is intended to represent.

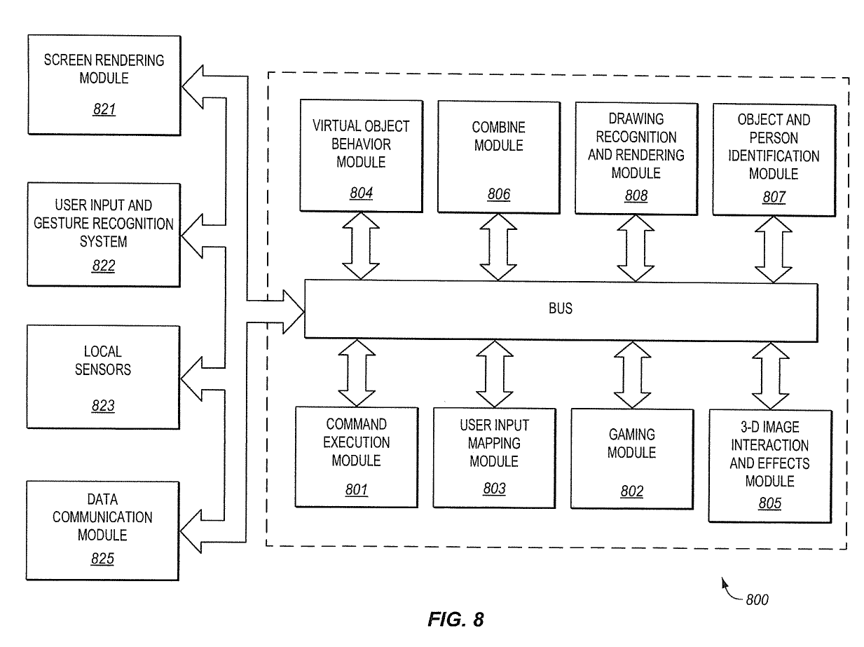

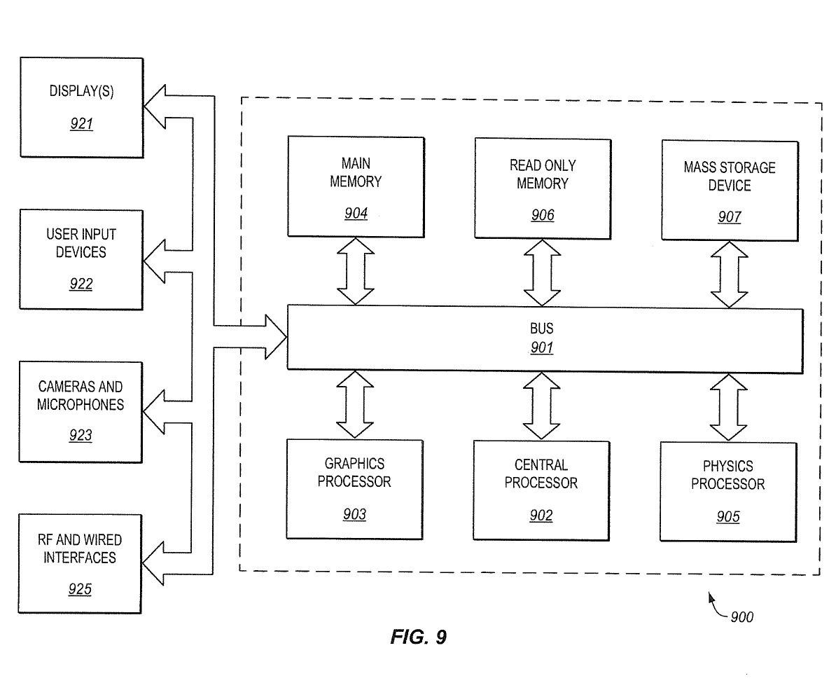

FIG. 8 is a block diagram of a computing environment capable of supporting the operations discussed above. The modules and systems can be implemented in a variety of different hardware architectures and form factors including that shown in FIG. 9. In the diagram, external interface processes are presented outside of the system box and internal computation processes are presented within the box, however, the operations and processes may be rearranged to suit other implementations.

The Command Execution Module 801 includes a central processing unit to cache and execute commands and to distribute tasks among the other modules and systems shown. It may include an instruction stack, a cache memory to store intermediate and final results, and mass memory to store applications and operating systems. The Command Execution Module may also serve as a central coordination and task allocation unit for the system.

The Screen Rendering Module 821 draws objects on one or more screens of the local device for the user to see. It can be adapted to receive the data from the Virtual Object Behavior Module 804, described below, and to render drawn objects, virtual objects, and any other objects on the appropriate screen or screens. Thus, the data from a Drawing Recognition and Rendering Module 808 would determine the position of and appearance of a 2D object on a screen and the Virtual Object Behavior Module would determine the position and dynamics of the corresponding virtual object after the 2D object is brought into 3D and manipulated using gestures. For example the Screen Rendering Module 821 would depict the virtual object and associated objects and environment on a screen, accordingly.

The User Input and Gesture Recognition System 822 may be adapted to recognize user inputs and commands including hand and aim gestures of a user. Such a module may be used to recognize hands, fingers, finger gestures, hand movements and a location of hands relative to displays. For example, the Object and Gesture Recognition Module could determine that a user made a gesture to extend an object in a third dimension and to drop or throw a virtual object into or onto an image at various locations. The User Input and Gesture Recognition System may be coupled to a camera or camera array, a microphone or microphone array, a touch screen or touch surface, or a pointing device, or some combination of these items, to detect gestures and commands from the user.

The Local Sensors 823 may include any of the sensors mentioned above that may be offered or available on the local device. These may include those typically available on a smart phone such as front and rear cameras, microphones, positioning systems, Wi-Fi and FM antennas, accelerometers, and compasses. These sensors not only provide location awareness but also allow the local device to determine its orientation and movement when interacting with other devices or an environment.

The Data Communication Module 825 contains the wired or wireless data interfaces that allow all of the devices in a system to communicate. There may be multiple interfaces with each device. In one example, the main computing system communicates wirelessly with touch pads, pointing devices, displays, and network resources. It may communicate over Bluetooth to send user commands and to receive audio to play through the connected devices. Any suitable wired or wireless device communication protocols may be used.

The Virtual Object Behavior Module 804 is adapted to receive input from the other modules, and to apply such input to any virtual objects that have been generated and that are being shown in the display. Thus, for example, the User Input and Gesture Recognition System 822 would interpret a user gesture and by mapping the captured movements of a user's hand to recognized movements, the Virtual Object Behavior Module 804 would associate the virtual object's position and movements to the user input to generate data that would direct the movements of the virtual object to correspond to user input.

The Virtual Object Behavior Module 804 may also be adapted to track where virtual objects (generated 3D objects and AR characters) should be in three dimensional space around the computer screen(s). This module may also track virtual objects as they move from one display to another. The contribution of this module is to track the virtual location of any virtual objects.

The Combine Module 806 alters a rendered, selected, or archival 2D image to add details and parameters provided by a user or a software environment and to add 3D information provided by the user through the local sensors 823 on the client device. This module may reside on the client device or on a “cloud” server.

The Drawing Recognition and Rendering Module 808 receives information from the User Input and Gesture Recognition System 822 and the Local Sensors 823 and vectorizes raster images created by the user or provides images from a library. It also renders changes provided by the user that allow the user to stretch, skew, and move onscreen objects in any of three dimensions using touch, air gestures, or pointing device input. It then provides these renderings to the Screen Rendering Module 821 to create the visual elements that appear on the screen.

The Object and Person Identification Module 807 uses received camera data to identify particular real objects and persons. The user may use object identification to introduce a two dimensional graphical object or a controller device. The objects may be compared to image libraries to identify the object. People can be identified using face recognition techniques or by receiving data from a device associated with the identified person through a personal, local, or cellular network. Having identified objects and persons, the identities can then be applied to other data and provided to the Drawing Recognition and Rendering Module 808 to generate suitable representations of the objects and people for display. The module may also be used to authenticate user accounts.

The User Input Mapping Module 803 coordinates timing of user input, coordinates vectorization of user and library graphics, and then tracks user touch and gesture input to manipulate the created object in 3 dimensions. It may also track input from the Virtual Object Behavior Module 804 to map input the user gives to interact with a 3D object that the user created.

The Gaming Module 802 provides additional interaction and effects. The Gaming Module 802 may generate virtual characters and virtual objects to add to the augmented image. It may also provide any number of gaming effects to the virtual objects or as virtual interactions with real objects or avatars. The game play of e.g. FIGS. 2B, 5A and 5B may all be provided by the Gaming Module. The Gaming Module 802 may also be used to generate sound effects. The sound effects may be generated as feedback for the creation of the virtual objects as well as for the use of the virtual objects.

The 3-D Image Interaction and Effects Module 805 tracks user interaction with real and virtual objects in the augmented images and determines the influence of objects in the z-axis (towards and away from the plane of the screen). It provides additional processing resources to provide these effects together with the relative′influence of objects upon each other in three-dimensions. For example, a user gesture to throw or launch an object can be tracked in 3D to determine how the object travels. The module may also provide data and physics for rendering objects in three dimensions. The 3-D Image Interaction and Effects Module 805 may also be used to generate sound effects. The sound effects may be generated as feedback for the creation of the virtual objects as well as for the use of the virtual objects. Special sounds may be generated when a shape is grasped or contacted and when the shape is manipulated. For an air gesture to move part of an object away from the display, the module may provide a sound to confirm the start of the gesture and the end of the gesture, as well as a sound to accompany the gesture indicating extent of movement, displacement from the screen and other aspects of the gesture.

FIG. 9 is a block diagram of a computing system, such as a personal computer, gaming console, smart phone or portable gaming device. The computer system 900 includes a bus or other communication means 901 for communicating information, and a processing means such as a microprocessor 902 coupled with the bus 901 for processing information. The computer system may be augmented with a graphics processor 903 specifically for rendering graphics through parallel pipelines and a physics processor 905 for calculating physics interactions as described above. These processors may be incorporated into the central processor 902 or provided as one or more separate processors.

The computer system 900 further includes a main memory 904, such as a random access memory (RAM) or other dynamic data storage device, coupled to the bus 901 for storing information and instructions to be executed by the processor 902. The main memory also may be used for storing temporary variables or other intermediate information during execution of instructions by the processor. The computer system may also include a nonvolatile memory 906, such as a read only memory (ROM) or other static data storage device coupled to the bus for storing static information and instructions for the processor.

A mass memory 907 such as a magnetic disk, optical disc, or solid state array and its corresponding drive may also be coupled to the bus of the computer system for storing information and instructions. The computer system can also be coupled via the bus to a display device or monitor 921, such as a Liquid Crystal Display (LCD) or Organic Light Emitting Diode (OLED) array, for displaying information to a user. For example, graphical and textual indications of installation status, operations status and other information may be presented to the user on the display device, in addition to the various views and user interactions discussed above. The display may also include audio and haptic components, such as speakers and oscillators to provide additional information to the user as sound, vibrations, and other effects.

Typically, user input devices 922, such as a keyboard with alphanumeric, function and other keys may be coupled to the bus for communicating information and command selections to the processor. Additional user input devices may include a cursor control input device such as a mouse, a trackball, a track pad, or cursor direction keys can be coupled to the bus for communicating direction information and command selections to the processor and to control cursor movement on the display 921.

Camera and microphone arrays 923 are coupled to the bus to observe gestures, record audio and video and to receive visual and audio commands as mentioned above.

Communications interfaces 925 are also coupled to the bus 901. The communication interfaces may include a modem, a network interface card, or other well known interface devices, such as those used for coupling to Ethernet, token ring, or other types of physical wired or wireless attachments for purposes of providing a communication link to support a local or wide area network (LAN or WAN), for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of the exemplary systems 800 and 900 will vary from implementation to implementation depending upon numerous factors, such as price constraints, performance requirements, technological improvements, or other circumstances. Examples of the electronic device or computer system may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments of the present invention. A machine-readable medium may include, but is not limited to, floppy diskettes, optical disks, CD-ROMs (Compact Disc-Read Only Memories), and magneto-optical disks, ROMs (Read Only Memories), RAMS (Random Access Memories), EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection). Accordingly, as used herein, a machine-readable medium may, but is not required to, comprise such a carrier wave.

References to “one embodiment”, “an embodiment”, “example embodiment”, “various embodiments”, etc., indicate that the embodiment(s) of the invention so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following examples pertain to further embodiments. Specifics in the examples may be used anywhere in one or more embodiments. In one embodiment, a method comprises: receiving a selection of a shape; presenting the selected shape on a display; observing a gesture to move at least a part of the presented shape away from the display; modifying the presented shape based on the observed gesture in the direction away from the display corresponding to the observed gesture; and presenting the modified shape as a three dimensional virtual object after modifying the presented shape based on the observed gesture.

Embodiments include the above method wherein the presented shape is a two-dimensional shape and wherein modifying the presented shape comprises adding a third dimension to the two dimensional shape to generate a three-dimensional shape.

Embodiments include either of the above methods, wherein the presented shape is a curve or wherein the presented shape is an enclosed shape having an area and the three-dimensional virtual object has a volume.

Embodiments include any of the above methods wherein the presented shape is a two dimensional picture.

Embodiments include any of the above methods wherein presenting the modified shape comprises displaying the modified shape in three dimensions on a three dimensional display.

Embodiments include any of the above methods further comprising receiving a selection of a part of the presented shape by detecting a gesture on a touch screen and wherein observing the gesture comprises observing the gesture to move the selected part of the presented shape.

Embodiments include the above method wherein observing a gesture comprises observing a gesture to push the selected portion of the presented shape away from the display into a plane of the display upon which the shape is presented or wherein the presented shape is a two dimensional shape and wherein modifying the presented shape comprises adding a third dimension to the two dimensional shape based on the pushing gesture, or wherein the extent of the third dimension is determined based on the pushing gesture.

Embodiments include any of the above methods wherein receiving a selection of a shape comprises at least one of observing an air gesture with a camera, receiving a voice command, and receiving a touch screen command or wherein observing a gesture comprises observing a grasping gesture directed to a part of the presented shape and a pulling of the grasped part of the presented shape away from a two dimensional display into a third dimension.

Embodiments include any of the above methods further comprising receiving a user input to draw the presented shape on the display and wherein presenting the shape on the display comprises presenting the drawn shape.

Embodiments include any of the above methods further comprising presenting sound effects based on the observed gesture to indicate the amount of movement away from the display.

Embodiments include any of the above methods further comprising launching a virtual object to interact with the modified shape and presenting the interaction on the display.

Embodiments include any of the above methods further comprising observing further gestures to interact with the modified shape and presenting the interaction on the display.

In another embodiment a machine-readable medium having instructions that when operated on by a computer cause the computer to perform operations comprises: receiving a selection of a shape; presenting the selected shape on a display; observing a gesture to move at least a part of the presented shape away from the display; modifying the presented shape based on the observed gesture in the direction away from the display corresponding to the observed gesture; and presenting the modified shape as a three dimensional virtual object after modifying the presented shape based on the observed gesture.

Embodiments include the medium above the operations further comprising receiving a gesture start command before observing the gesture and a gesture end command to cause the end of observing the gesture.

Embodiments include either of the media above wherein observing a gesture comprises observing a grasping gesture as a start command and observing a release gesture as an end command.

In another embodiment an apparatus comprises: a gesture input and recognition system to receive a selection of a shape; a screen rendering module to present the selected shape on a display, the gesture input and recognition system to further observe a gesture to move at least a part of the presented shape away from the display; and a drawing recognition and rendering module to modify the presented shape based on the observed gesture in the direction away from the display corresponding to the observed gesture, the screen rendering module to present the modified shape as a three dimensional virtual object after modifying the presented shape based on the observed gesture.

Embodiments include the apparatus above wherein gesture input and recognition module determines an extent of movement away from the display and wherein the drawing recognition and rendering module provides an amount of the third dimension based on the extent of movement.

Embodiments include either of the apparatus above wherein the gesture input and recognition system includes a camera to observe air gestures and a touch screen interface to receive touch screen commands.

In another embodiment an apparatus comprises means for performing any one or more of the operations mentioned above.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

What is claimed is:

1. A method comprising:
receiving a selection of a shape;
presenting the selected shape on a display;
observing a gesture to move at least a part of the presented shape away from the display;
modifying the presented shape based on the observed gesture in the direction away from the display corresponding to the observed gesture; and
presenting the modified shape as a three dimensional virtual object after modifying the presented shape based on the observed gesture.

2. The method of claim 1, wherein the presented shape is a two-dimensional shape and wherein modifying the presented shape comprises adding a third dimension to the two dimensional shape to generate a three-dimensional shape.

3. The method of claim 1, wherein the presented shape is a curve.

4. The method of claim 1, wherein the presented shape is an enclosed shape having an area and the three-dimensional virtual object has a volume.

5. The method of claim 1, wherein the presented shape is a two dimensional picture.

6. The method of claim 1, wherein presenting the modified shape comprises displaying the modified shape in three dimensions on a three dimensional display.

7. The method of claim 1, further comprising receiving a selection of a part of the presented shape by detecting a gesture on a touch screen and wherein observing the gesture comprises observing the gesture to move the selected part of the presented shape.

8. The method of claim 7, wherein observing a gesture comprises observing a gesture to push the selected portion of the presented shape away from the display into a plane of the display upon which the shape is presented.

9. The method of claim 8, wherein the presented shape is a two dimensional shape and wherein modifying the presented shape comprises adding a third dimension to the two dimensional shape based on the pushing gesture.

10. The method of claim 9, wherein the extent of the third dimension is determined based on the pushing gesture.

11. The method of claim 1, wherein receiving a selection of a shape comprises at least one of observing an air gesture with a camera, receiving a voice command, and receiving a touch screen command.

12. The method of claim 1, wherein observing a gesture comprises observing a grasping gesture directed to a part of the presented shape and a pulling of the grasped part of the presented shape away from a two dimensional display into a third dimension.

13. The method of claim 1, further comprising receiving a user input to draw the presented shape on the display and wherein presenting the shape on the display comprises presenting the drawn shape.

14. The method of claim 1, further comprising presenting sound effects based on the observed gesture to indicate the amount of movement away from the display.

15. The method of claim 1, further comprising launching a virtual object to interact with the modified shape and presenting the interaction on the display.

16. The method of claim 1, further comprising observing further gestures to interact with the modified shape and presenting the interaction on the display.

17. A machine-readable medium having instructions that when operated on by a computer cause the computer to perform operations comprising:
receiving a selection of a shape;
presenting the selected shape on a display;
observing a gesture to move at least a part of the presented shape away from the display;
modifying the presented shape based on the observed gesture in the direction away from the display corresponding to the observed gesture; and
presenting the modified shape as a three dimensional virtual object after modifying the presented shape based on the observed gesture.

18. The medium of claim 17, the operations further comprising receiving a gesture start command before observing the gesture and a gesture end command to cause the end of observing the gesture.

19. The medium of claim 18, wherein observing a gesture comprises observing a grasping gesture as a start command and observing a release gesture as an end command.

20. An apparatus comprising:
a gesture input and recognition system to receive a selection of a shape;
a screen rendering module to present the selected shape on a display, the gesture input and recognition system to further observe a gesture to move at least a part of the presented shape away from the display; and
a drawing recognition and rendering module to modify the presented shape based on the observed gesture in the direction away from the display corresponding to the observed gesture, the screen rendering module to present the modified shape as a three dimensional virtual object after modifying the presented shape based on the observed gesture.

21. The apparatus of claim 20 wherein gesture input and recognition module determines an extent of movement away from the display and wherein the drawing recognition and rendering module provides an amount of the third dimension based on the extent of movement.

22. The apparatus of claim 20, wherein the gesture input and recognition system includes a camera to observe air gestures and a touch screen interface to receive touch screen commands.

23. An apparatus comprising means for performing each of the operations of claim 1.
